(19) United States
(12) Patent Application Publication
(10) Pub. No.: US 2008/0101565 A1
(43) Pub. Date: May 1, 2008

(54) AUTOMATED HEALTHCARE MANAGEMENT FUNCTIONS

(75) Inventor: Stephen J. Tyler, Fort Wayne, IN (US)

Correspondence Address: BAKER & DANIELS LLP, 300 NORTH MERIDIAN STREET, SUITE 2700, INDIANAPOLIS, IN, 46204, US

(73) Assignee: TRIPRACTIX, LLC, Fort Wayne, IN (US)

(21) Appl. No.: 11/867,485

(22) Filed: Oct. 4, 2007

Related U.S. Application Data
(60) Provisional application No. 60/828,174, filed on Oct. 4, 2006.

(51) Int. Cl. H04M 11/00

(52) U.S. Cl. 379/93.01

(57) ABSTRACT

The present invention involves value-added applications (or middleware) that integrates and adds value to existing call system and medical software packages by leveraging the assets of telecommunications manager software and medical records software with further specialized software. The EXTENSION system provides a modular set of medical workflow based applications that tightly integrate with telephone, such as call manager systems, and information systems, such as medical software packages. This combination allows a greater level of productivity within the medical organization.

### BACKGROUND OF THE INVENTION

1. Field of the Invention

The present invention generally relates to computer networks for healthcare institutions. The invention more specifically relates to automating specific healthcare management functions.

2. Description of the Related Art

The approaches described in this section could be pursued, but are not necessarily approaches that have been previously conceived or pursued. Therefore, unless otherwise indicated herein, the approaches described in this section are not teachings or suggestions of the prior art to the claims in this application and are not admitted to be prior art by inclusion in this section.

Healthcare management looks to technology to improve the efficient delivery of healthcare services to the public. This includes both information technology and telecommunications. Physician's offices are particularly tied to telephones. The importance of a modernized telephone system should never be underestimated, especially in today's business world. Telephone communications are an integral part of the engineering of businesses and organizations, playing an important role in the operation, development and achievement of business goals. Each day, countless businesses utilize the telephone system to conduct a vast range of business transactions.

With the advent of the Internet, “packet” based communications networks have been created that transmit signals in discrete packages rather than over fixed circuits. Perhaps the most notable such network is the Internet Protocol (IP) telephone system. The technology used to transmit voice conversations over a data network using the Internet Protocol is known as Voice over Internet Protocol, or VoIP. Such a data network may be the Internet or a corporate Intranet. The primary motivations for using such a system are cost and convenience as VoIP is significantly less expensive than typical telephone land line costs, plus one high speed Internet connection may serve for multiple phone lines.

Call control systems are used to manage IP phones in VoIP networks. Commercial examples of call control systems include Cisco Call Manager, commercially available from Cisco Systems, Inc., San Jose, Calif. Cisco Call Manager is the software-based call-processing component of the Cisco IP telephony solution. The software extends enterprise telephony features and functions to packet telephony network devices such as IP phones, media processing devices, voice-over-IP (VoIP) gateways, and multimedia applications. Cisco Call Manager is essentially an IP-based Public Branch Exchange (PBX) that enables companies to carry their voice and data traffic on a single network infrastructure.

Cisco Unity is a Unified Communications system that provides advanced, convergence-based communication services such as voice and unified messaging. Cisco Unity Unified Messaging—an integral component of the Cisco IP Communications system—is a foundational element in bringing unified communication solutions to enterprise-scale organizations. It provides unified messaging (e-mail, voice, and fax messages sent to one inbox) and intelligent voice messaging (full-featured voice mail providing advanced functions) to improve communications, boost productivity, and enhance customer service capabilities across an organization. It provides advanced, convergence-based communication services and integrates them with common desktop applications. With Cisco Unity Unified Messaging, a user may listen to e-mail over the telephone, check voice messages from the Internet, and send, receive, or forward faxes to multiple locations. Cisco Unity Voice Messaging features robust automated-attendant functions that include intelligent routing and easily customizable call-screening and message-notification options.

In addition to telecommunications, computers and computer software can improve the efficiency of delivery of healthcare services. Many software applications have been written to assist physicians in managing their offices. One commercial example is Centricity Physician Office—Practice Management (formerly Millbrook Practice Manager), available from GE Medical Systems headquartered in the United Kingdom. Centricity Practice Management provides a comprehensive solution to healthcare computing needs—from billing and scheduling to patient information, inventory control, scanning, EDI (electronic submission, remittance, statements and eligibility) and managed care.

Another GE software product, Centricity EMR (formerly Logician), is an electronic medical record (EMR) system that enables ambulatory care physicians and clinical staff to document patient encounters, streamline clinical workflow, and securely exchange clinical data with other providers, patients, and information systems. Centricity EMR is used by thousands of physicians to manage millions of patient records.

### SUMMARY OF THE INVENTION

The invention relates to a medical information system with a server running telephony manager software and medical data manager software. The telephony manager software is capable of performing a telephony process and has data related to a telephony call. The medical data manager software is capable of performing a data manager process and includes a plurality of patient records. Collaborative software running on the server is capable of interacting with the telephony manager software and the medical data manager software to provide data from one of the telephony manager or medical data manager software to a process on the other of the telephony manager software and medical data manager software.

The present invention involves value-added applications (or middleware) that integrates and adds value to existing call system and medical software packages by leveraging the assets of telecommunications manager software and medical records software with further specialized software. The EXTENSION system discussed in this disclosure is a modular set of medical workflow based applications that tightly integrate with existing call manager systems and medical software packages, allowing telephony and information systems to communicate and interact. This unique combination allows a greater level of productivity within the medical organization. The EXTENSION system is a modular system in that each workflow application is a separate program referred to as a ‘component.’ Each component communicates with a central application where configuration information and common data is stored. The central application is referred to as the ‘core.’

One component of the EXTENSION system is the Portal component. The portal component provides a set of tools for integrating patient information into secure websites. Information such as patient demographics, insurance details and upcoming appointments may be displayed in custom-built websites using the Portal component. The Portal component exposes a web service Application Program Interface (API) for displaying EXTENSION data in websites. It also retrieves data from Common Data and other components as needed. The Portal allows access control enabling a customer administrator to determine what information is available.

Another component in the EXTENSION system is a call answering service. The process begins when a patient makes a telephone call to an office utilizing the system. The caller's telephone number is ascertained, either by DiD, caller ID, or similar method. The caller's telephone number is transmitted to a computer utilizing the middleware. The component validates the patient by matching the caller's telephone number with existing patient data. If patient is validated, the patient is forwarded to an attending physician or asked to leave a message for an on-call physician. The caller is routed to an operator if not validated.

Another component in the EXTENSION system is an automatic chart pull service. When a patient makes a call to the healthcare facility, the caller's telephone number is ascertained and transmitted to the middleware. Using existing patent data, the patient is validated by matching the telephone number with numbers in a patient database. The patient's chart is retrieved from the patient database and displayed on a display device. The caller is routed to an operator if not validated.

Another component of the present invention a dictation and transcription service that integrates with a call system package, along with EMR. The EMR system is used to document patient encounters, streamline clinical workflow, and securely exchange clinical data with other providers, patients, and information systems. The transcription component integrates directly into EMR. Because it is IP based, VoIP phones can easily be placed at any healthcare establishment in the world, providing a simple way to exchange information. When using a VoIP phone connected to the system, what is dictated is captured by a dictation module, transcribed by the transcription component and entered into an EMR system record.

Another component of the present invention is a notification or appointment reminder service. An administration website may be used to define when and how to notify patients. The application queries all records in common data store containing patient data on a user-defined schedule. For each patient scheduled for an appointment in the next seven days, for example, notification in the form of an email, mailed letter, or telephone call is made to the patient reminding the patient of the upcoming appointment.

Another component of the EXTENSION system is The IP Phone Service Gateway. The Gateway acts as a conduit between external components and VoIP phones. Forms managed by the Gateway are published in a call manager application for use by phones as applicable. The Gateway provides both a web based interface and a web service (SOAP or XML-RPC) as a means of defining and managing forms. The Gateway allows for the generation of XML forms for consumption by VoIP phones. It allows for defining and managing forms via a web interface. It provides SOAP/XML-RPC interface for use by external components. The Gateway allows for communication with external sources via SOAP/XML-RPC to obtain data for use in forms.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 depicts a block diagram of the EXTENSION system.

FIG. 2 is a block diagram depicting the relationship between the web portal and other applications.

FIG. 3a is a block diagram depicting the Call-Answering service component of the present invention.

FIG. 3b is a flow chart diagram illustrating an exemplary method for the Call-Answering service.

FIG. 4a is a block diagram depicting the Transcription component of the present invention.

FIG. 4b is a flow chart diagram depicting the Transcription component of the present invention.

FIG. 5a is a block diagram depicting the Notification component of the present invention.

FIG. 5b is a flow chart diagram depicting the Notification component of the present invention.

FIG. 6 is a diagram depicting the IP Phone Service Gateway component of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions that follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory; rather they represent specific electronic structural elements that impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general-purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus. In particular, various general-purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an objects method until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions that may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms that are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers that are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the workstation and the network server and for displaying and interacting with the network user. Browsers are designed to utilize a communications protocol for transmission of text and graphic information over a worldwide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information that is formatted in a Standard Generalized Markup Language (“SGML”) or a HyperText Markup Language (“HTML”), both being scripting languages that embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method). “XML-RPC” is a remote procedure call protocol encoded in XML. It is considered the ancestor of SOAP. It is a very simple protocol, defining only a handful of data types and commands, and the entire description can be printed on two pages of paper.

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical. “HTTPS” or “HyperText Transfer Protocol Secure” is a secure protocol to transfer information across the web by encrypting the information before transferring.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”). The terms “wireless application protocol” or “WAP” mean a universal specification to facilitate the delivery and presentation of web-based data on handheld and mobile devices with small user interfaces. The term “SMS” refers to short message service, a form of text messaging on mobile phones.

“EMR” or “Electronic Medical Record” generally refers to a beneficiary/patient medical record in electronic form that is accessible from numerous other systems. “HL7” or “Health Level 7” is an international standard for data exchange between computer systems in healthcare. It provides interoperability between electronic Patient Administration Systems (PAS), Electronic Practice Management (EPM) systems, Laboratory Information Systems (LIS), Dietary, Pharmacy and Billing systems as well as Electronic Medical Record (EMR) or Electronic Health Record (EHR) systems. “HL7 SIU” is a message received whenever a patient appointment is added, rescheduled, updated or cancelled in the EMR system.

“DiD” or “Direct Inward Dial” generally refers to a specially configured phone line from the telephone company that allows for dialing inside a company directly without attendant assistance. A DID line cannot be used for out dial operation since there is no dial tone offered. “PBX” or “Private Branch Exchange” refers to an automated telephone switching system serving one company, located on the company's premises, and connecting to the public telephone network. “Portal” is a Web site or service that offers a broad array of resources and services.

“SCCP” or “Skinny Client Control Protocol” is a communications protocol for signaling the hardware endpoints of a VoIP system, such as IP phones. “SIP” or “Session Initiation Protocol” refers to a multimedia and telephony protocol that provides services including call forwarding, number delivery, authentication and other telecoms applications. “SOAP” or “Simple Object Access Protocol” is a lightweight protocol for exchange of information in a decentralized, distributed environment. It is an XML-based protocol that consists of three parts: an envelope that defines a framework for describing what is in a message and how to process it, a set of encoding rules for expressing instances of application-defined data types, and a convention for representing remote procedure calls and responses. “Telephony” generally refers to voice-oriented communications technology as a whole. It involves the two-way transmission of audio over a packet-switched IP network. When used in a private intranet, wide area network (WAN), or the Internet it is generally known as “voice over IP,” or “VoIP.” “VOIP” or “Voice over Internet Protocol” refers to a category of hardware and software that enables people to use the Internet as the transmission medium for telephone calls. VoIP works through sending voice information in digital form in packets, rather than in the traditional circuit-committed protocols of the public switched telephone network.

Cisco Call Manager (hereinafter referred to as “Call Manager”), Cisco Unity Unified Messaging and Cisco Unity Voice Messaging (hereinafter referred to as “Unity”), Centricity Physician Office—Practice Management software (hereinafter referred to as “Practice Management”), and Centricity EMR (hereinafter referred to as “EMR”) are used throughout the application when describing an exemplary embodiment of the systems and methods of the present invention. These are used for illustrative purposes only in order to simply the discussions and it is not intended that the systems and methods of the present invention be limited to these specific commercial packages for telephony or information systems. Such references are intended to cover any such telecommunications system, information system, or medical records system in a generic sense.

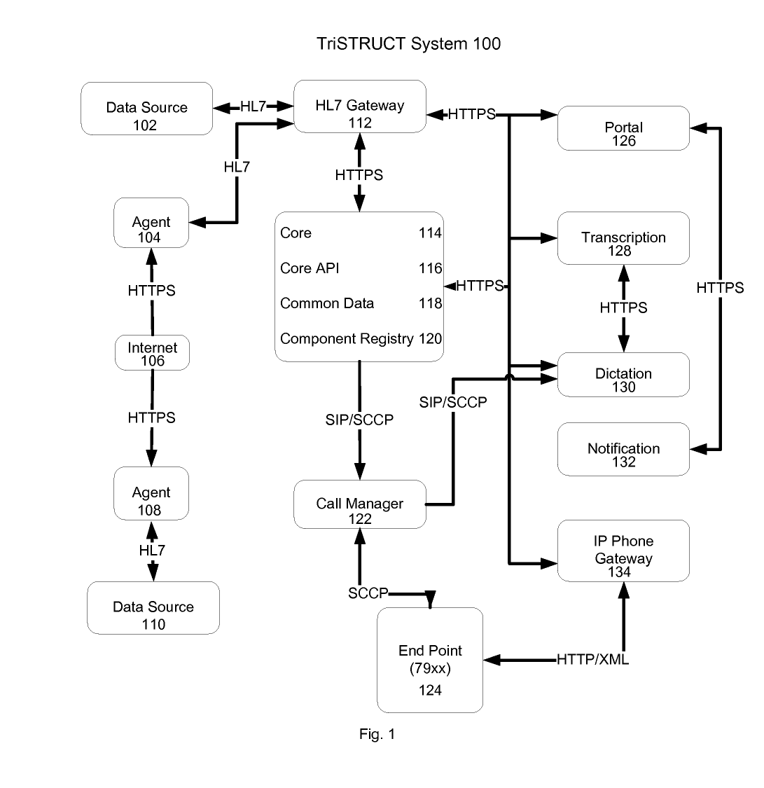

In one embodiment, EXTENSION system 100 provides a modular set of medical workflow based applications that tightly integrate with Centricity Physician Office and Cisco Unified Communications, as depicted in FIG. 1. Each workflow application is a separate application, referred to as a component. Each component communicates with Core 114, which is integrated with a Session Initiation Protocol (SIP) Trunk (an application-layer control or signaling protocol for creating, modifying, and terminating sessions with one or more participants to create two-party, multiparty, or multicast sessions that include Internet telephone calls, multimedia distribution, and multimedia conferences) that also supports connection with many other VoIP based systems, in this case referred to as Call Manager 122. Core 114 acts as the central brain of the integrated system and is generally present in some form in any implementation, and communicates with components such as Portal 126, Transcription 128, Dictation 130, Notification 132, and/or IP Phone Gateway 134. To link in with telephony, Core 114 communicates with End Point 124 (typically a handset for an individual) via Call Manager 122 or IP Phone Gateway 134. Core 114 is the central application where configuration information and common data are stored, providing a collaborative environment for the interaction of telephony and information systems as described in several exemplary embodiments below. The components may be chosen based on required features.

Core 114 is functionally broken down into at least three pieces: Component Registry 120, Common Data Store 118 and Core API 116. Component Registry 120 represents data on the various components in Core 114, tracking the existence and configuration of all of the components installed. When a new component is implemented, its first task is to store such configurations, or register, with the core. While the remaining disclosure involves embodiments showing the interconnection of a medical information system with a telecommunications system, the invention may be implemented in other domains, e.g., connecting a financial or inventory system with a telecommunications system. Thusly, HL7 Gateway 112 may be replaced by another component directed to another domain.

Each component is designed as a workhorse that has no immediate knowledge of its surroundings. In other words, the configuration data is stored in Component Registry 120 such that should the server running the component process fail, a new process may take over with minimal intervention. Components may have dependencies, such as transcription requires dictation. In such a case, the requirements are presented when registering. Component Registry 120 then responds with the whereabouts of the required components. In other embodiments of the invention, Core 114 provides a software mechanism for cross-linking various components without having an explicit reference to a component registry.

Although each component has its own unique responsibility, they all may share the same basic data set. Centricity Physician Office applications send data such as demographics and appointments via HL7 Gateway 112 to be stored in Data Sources 102 and/or 110. In this exemplary embodiment, data from HL7 Gateway 112 may be directly stored in Data Source 102, or transmitted through Agent 104 via Internet 106 to Agent 108 and ultimately stored in Data Source 110. A given implementation of EXTENSION Core 114 may receive data from any number of source applications, and potentially through several gateways. Each source uses a unique identifier that ensures its data is secure. Components implemented for a given client are required to present this identifier in order to gain access to the data.

HL7 Gateway 112 is responsible for communicating with external medical applications via HL7 Gateway 112. HL7 Gateway 112 receives HL7 messages from external sources such as Centricity EMR and transmits messages to similar destinations on behalf of other EXTENSION components. This data may also be maintained in Common Data Store 118 as part of Core 114 and made available to the components via Core API 116. Core API 116 provides the components with a standard means of retrieving data and obtaining registry information. The functions of Core API 116 are accessed via web service 106 to ensure that the features are available to components regardless of their platform or language. Core 114 is designed to receive data from Centricity Physician Office applications via HL7 Gateway 112, which is advantageous in that it isolates the framework from changes as a result of application updates. It also allows easier support of other applications should the need arise. Each time a new data source is added, a bridge is built between the source and Core 114.

The components of EXTENSION system 100 of the exemplary embodiment provide the functionality of the medical workflow applications. Each component is considered a specialist in its field. Each one is unique in its function and is only aware of its own responsibility. This ensures that the design of each component is simple, which results in faster development and easier maintenance. In a situation where a component requires the functionality of a different component in order to complete its task, it is considered a dependency. This dependency is reported to the component registry that responds with the connection details so that they may communicate directly.

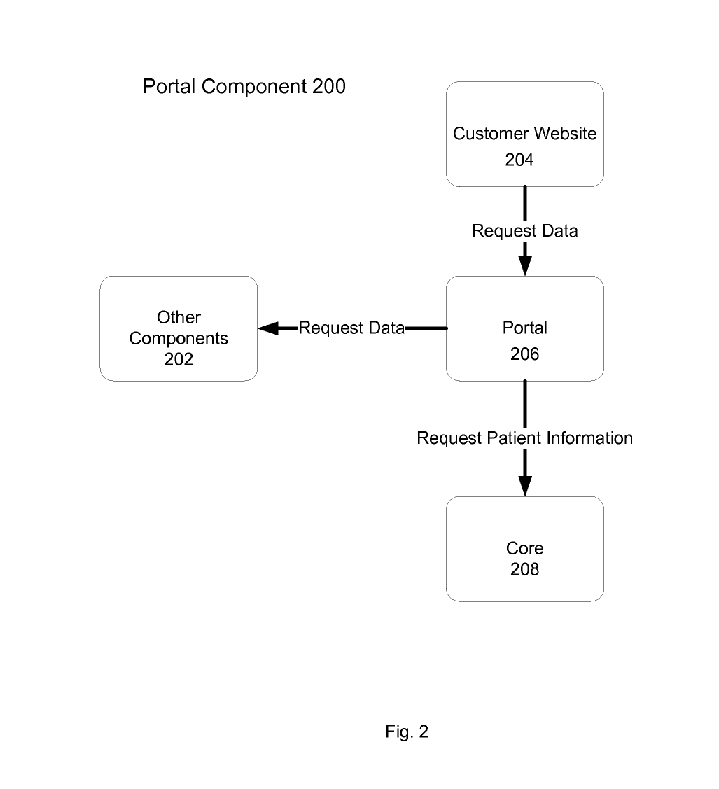

One component of EXTENSION system 100 is Portal component 200, as depicted in FIG. 2. FIG. 2 shows the relationship between web portal 206 and other applications. Portal component 200 provides a set of tools for integrating patient information into secure websites such as Customer Website 204. Such tools include a workflow component that is responsible for providing forms transformed in to a destination device's native format using XSLT. The workflow component of portal component 200 in turn talks any device that has an HTTP POST/GET mechanism such as PDA's, Smart Phones, Cisco 7900 Series phones, etc. Thus portal component 200 may be used to build a customized web site that makes use of data stored in and/or retrieved by Core 114. Information such as patient demographics, insurance details and upcoming appointments are retrieved from Core 208 and displayed in custom-built websites using Portal component 200. In addition, information from other components 202 may also be integrated enabling customers to consolidate their ongoing management of EXTENSION into a single view.

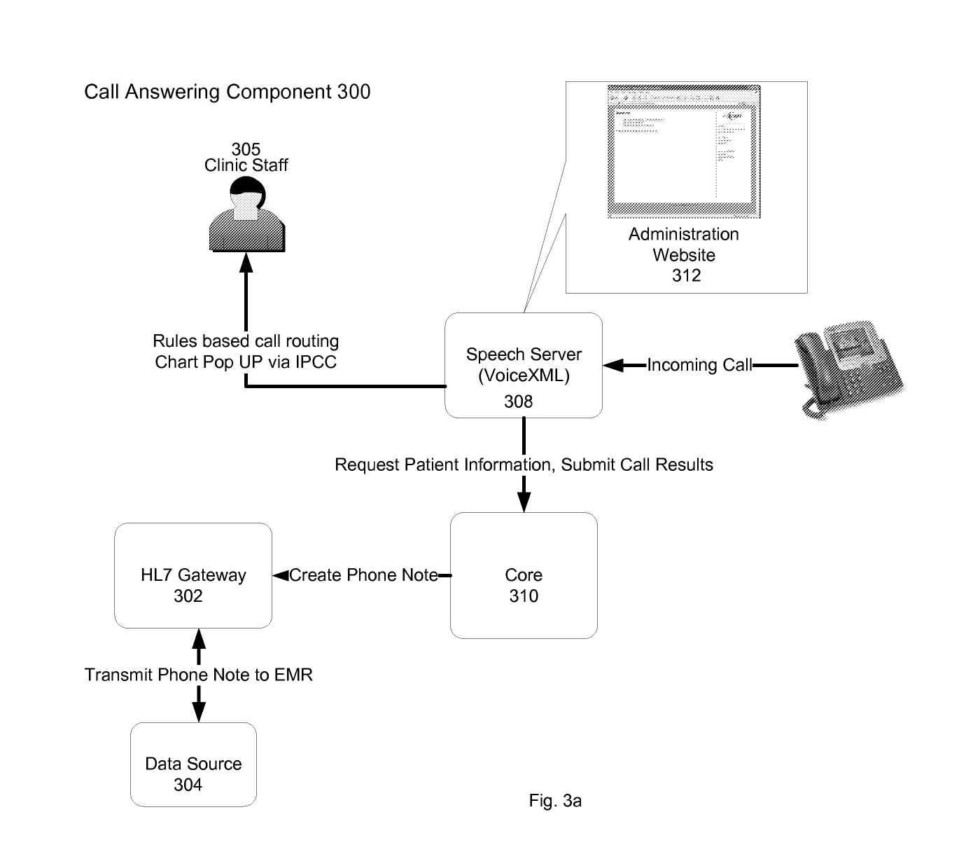

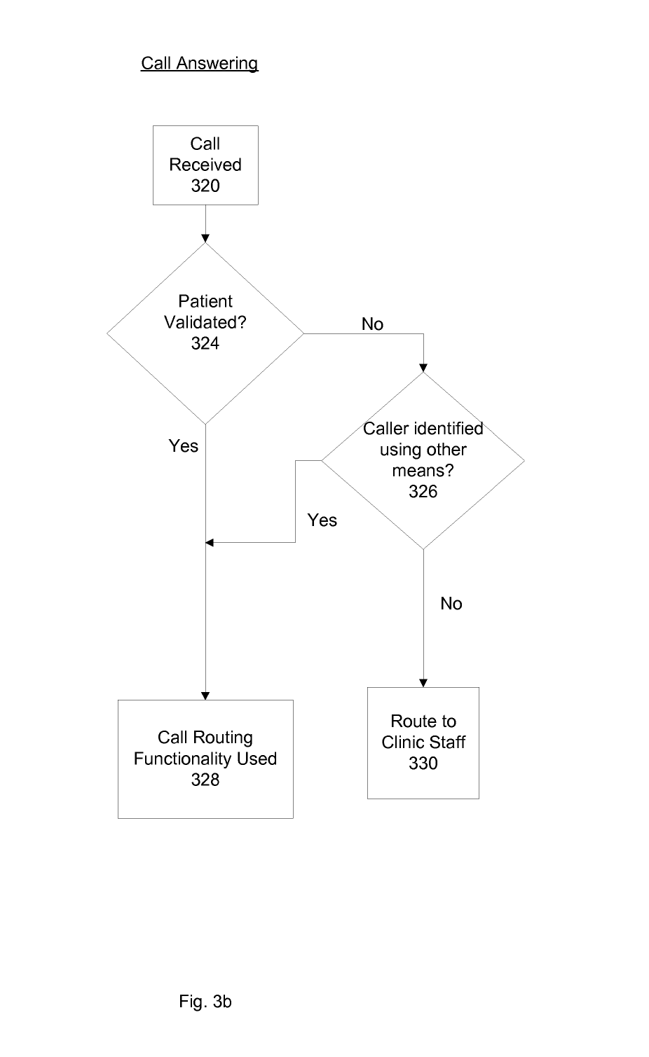

Another component of the present invention relates to a call answering service as illustrated in FIGS. 3a and 3b. Call Answering component 300 utilizes an existing call control system and healthcare management package. The call answering service uses Call Manager 122 and Practice Management (typically through HL7 Gateway 112) to validate an after-hours caller as a patient and forwards the patient to leave a message for an on-call physician or an attending physician. Call Answering utilizes patient information stored in and/or retrieved by Core 114 when traversing the phone system's call routing functionality.

Call Answering component 300 receives Incoming Call 314 (step 320) and attempts to identify caller via caller ID against patient information stored in Core 310 (step 324). If a singular match is not possible, IVR based questions asking for the patient to identify himself using predetermined fields such as date of birth or social security number may be used (step 326). Integrated Text-To-Speech (TTS) and Integrated Voice Recognition (IVR) are used so that the system can converse with the caller. If a match is still not possible, the call is routed to Clinic Staff 306 (step 330). Once the caller is identified, the phone systems call routing functionality can be used to resolve the call (step 328). A phone note document in EMR may be created and sent to Data Source 304 based on IVR questions answered by caller (such as RX refill requests, questions, etc.), possibly to be stored in a patient chart document.

The present invention, in another form, provides for an automatic chart (or patient record) pull when a patient calls a physician's office via Call Manager 112. The Chart Pull component's functionality is included with the FIG. 3a diagram. When the call gets routed to an individual, the IP Contact Center user agent is used to pull up the patients chart based on the information the Call Answering system has gathered.

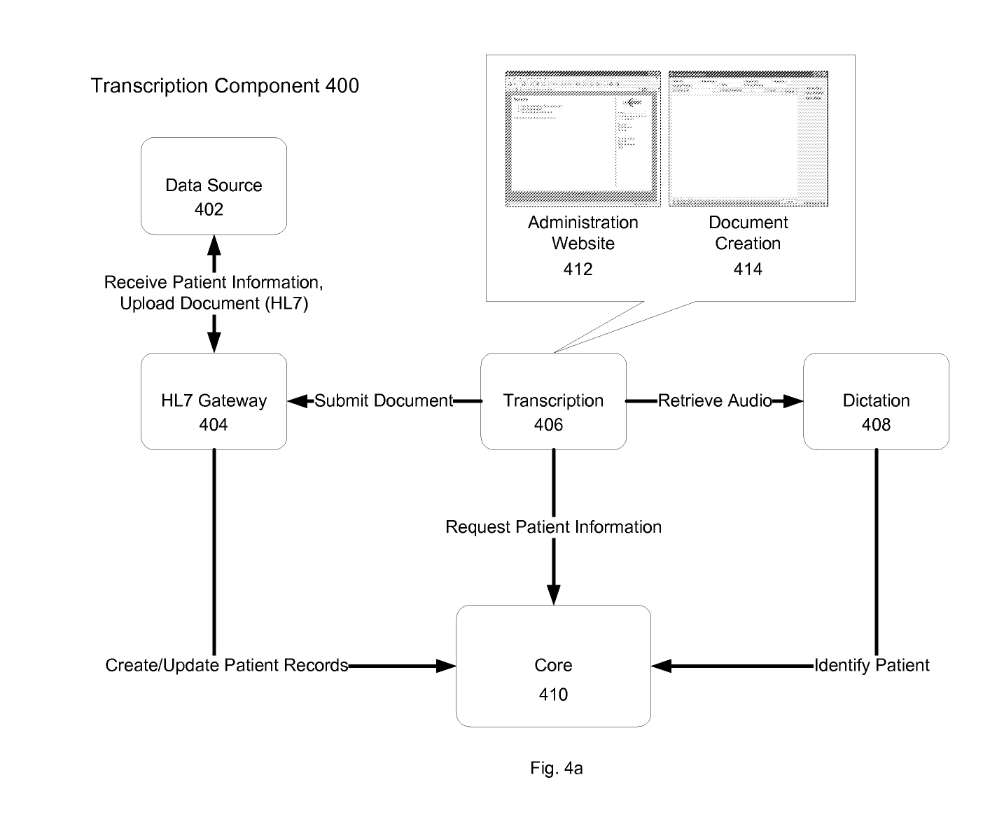

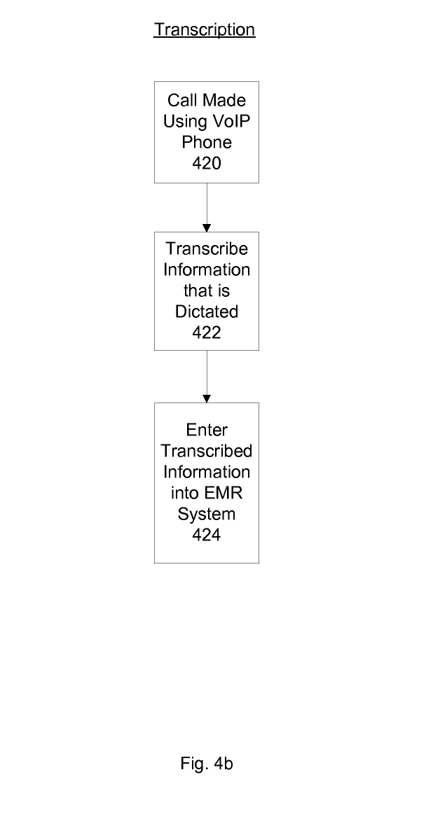

Another component of the present invention relates to Transcription component 400 as depicted in FIGS. 4a and 4b. Dictation is recorded via phone call (step 420) whereby Core 410 is used to identify the patient. Identifying the patient will vary based on the dictation method used (VoIP phone, Web site/Computer or external phone call). The combination of entering the patient's ID (clinic assigned record number) and comparing it against the provider's schedule of appointments that have not received dictation eases the process of ensuring accurate identification. Dictation module 408 then records speech for later transcription.

Transcription component 406 allows users to transcribe documents based on recordings retrieved from Dictation module 408 (step 422). Completed documents are stored for later modification as required in addition to being submitted to HL7 Gateway 404 for transmission to Data Source 402 (step 424). In the exemplary embodiment, Data Source 402 represents the EMR system. The EMR system is used to document patient encounters, streamline clinical workflow, and securely exchange clinical data with other providers, patients, and information systems. The type of dictation (letter, surgery note, etc.) determines the format of the document created in the EMR. Transcription 400 may also integrate with word processing applications.

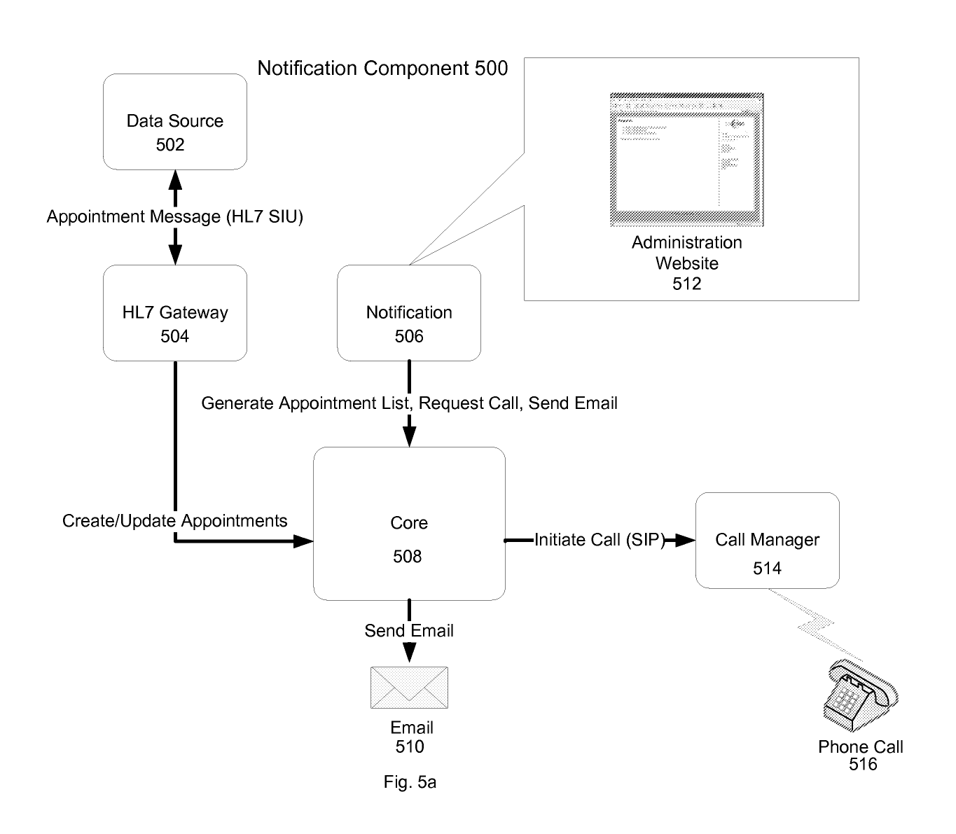

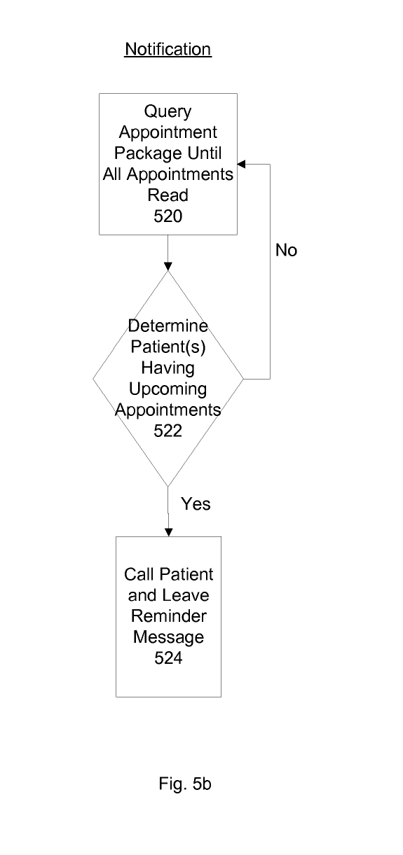

Another component of the present invention relates to a Notification component 500 depicted in FIGS. 5a and 5b. Notification component 506 is used to remind a person of an event. Reminders may be in the form of email 510, a letter printed and mailed or phone call 516 via Call Manager 514 (e.g., a VoIP server). A typical use is to notify patients of their upcoming appointments. The scheduling system is configured to send a message to HL7 Gateway 504 as soon as an appointment is scheduled. Administration Website may be used to define when and how to notify patients. The application queries all records in common data store containing patient data on a user-defined schedule (step 520). Notification 506 determines patient(s) having upcoming appointments (step 522). Rules defined by the user and stored by Notification component 506 dictate when the patient is contacted and the method used. Using the VoIP system, a call is placed to each patient scheduled for reminder and a message is left (step 524). The reminder message may state the date, time, and location of the appointment, along with the name of the physician. The reminder message may be in the form of an audio reminder, a SMS, or an e-mail.

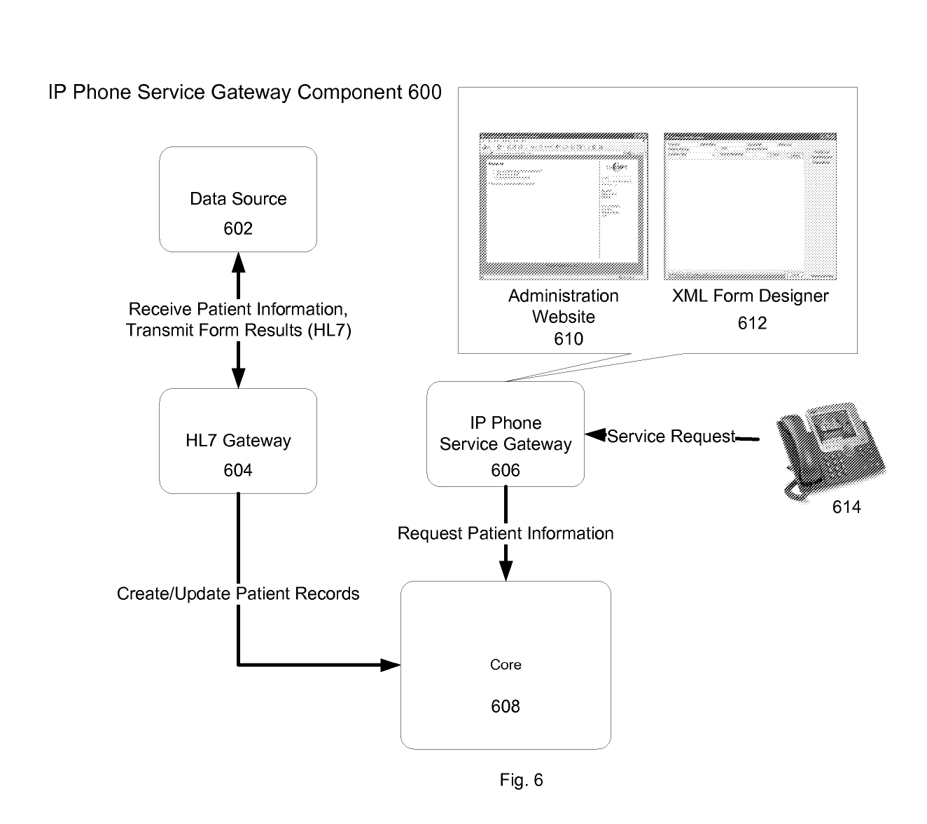

Another component of the present invention is the IP Phone Service Gateway, depicted in FIG. 6. IP Phone Service Gateway 606 acts as a conduit between external components and VoIP phone 614. Gateway 606 is used to generate XML forms for consumption by VoIP phones and to define/manage forms via web interface. Forms 610, 612 managed by Gateway 606 are published or available in the Call Manager application for use by VoIP phones 614 (or other VoIP enabled devices, such as a personal computer or a hand held computer, neither shown) as applicable. Gateway 606 provides both a web based interface and a web service as a means of defining and managing forms. An example of use would be for a form to retrieve patient information from Data Source 602 using HL7 Gateway 604 and initiate patient dictation. As VoIP phone 614 may include a video display and a graphic user interface device, such forms may be used by the operator of the telephone to obtain information from data source 602 that would assist with the placement of a call, the entry of dictation, or another data transfer from VoIP phone 614 through core 608 to an appropriate data receiver.

A still further component of the present invention involves a workflow component (not shown) that is responsible for providing forms transformed in to a destination device's native format using Extensible Stylesheet Language Transformations (XSLT). XSLT involves an XML-based language used for the transformation of XML documents into other XML or “human-readable” documents for various environments. This workflow component in turn talks to the portal component as well as any device that has an HTTP POST/GET mechanism such as PDA's, Smart Phones, Cisco 7900 Series phones, etc. The portal component is thus capable of building a customized web site that makes use of data stored in the core where functionality is needed beyond what the workflow component is able to provide.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A medical information system comprising:
a server;
telephony manager software running on said server, said telephony manager software capable of performing a telephony process and having data related to a telephony call;
medical data manager software running on said server, said medical data manager software capable of performing a data manager process and including a plurality of patient records; and
collaborative software running on said server and capable of interacting with said telephony manager software said medical data manager software, said collaborative software capable of providing data from one of said telephony manager software and said medical data manager software to a process on the other of said telephony manager software and said medical data manager software.

2. A call answering system comprising:
a server;
telecommunications manager software running on said server;
medical data manager software running on said server and including a plurality of patient records; and
cross-referencing software running on said server and capable of interacting with said telecommunications manager software to identify the number of an incoming call to said telecommunications manager software, said cross-referencing software capable of interacting with said medical data manager software to identify a particular patient record based on the number of the incoming call.

3. The call answering system of claim 2, further comprising web portal software capable of interacting with cross-referencing software to retrieve and display identified patient record via web portal.

4. The call answering system of claim 2 wherein data exchange between said cross-referencing software and said telecommunications manager software is done using HL7 messages.

5. The call answering system of claim 2 wherein data exchange between said cross-referencing software and said medical data manager software is done using HL7 messages.

6. An appointment reminder system comprising:
a server;
telecommunications manager software running on said server;
medical data manager software running on said server and including a plurality of patient records and a scheduler; and
appointment manager software running on said server and capable of interacting with said data manager software, said telecommunications manager software and said scheduler to determine patient records having an appointment scheduled.

7. The appointment reminder system of claim 6 wherein data exchange between said appointment manager software and said data manager software is done using HL7 messages.

8. The appointment reminder system of claim 6 wherein telecommunications manager software capable of sending an audio reminder message.

9. The appointment reminder system of claim 6 wherein telecommunications manager software capable of sending an electronic mail reminder message.

10. A medical dictation system comprising:
a server;
telecommunications manager software running on said server, said telecommunications manager software including transcription software capable of converting an audio message to a text message; and
medical practice management software running on said server and including a plurality of data records, said medical practice management software capable of associating text messages from said transcription software with particular data records.

11. The medical dictation system of claim 10 wherein said medical practice management software capable of updating said data records base on text messages.

12. The medical dictation system of claim 10 wherein data exchange between said telecommunications manager software and said medical practice management software is done using HL7 messages.

13. A call routing system including:
a server;
telecommunications manager software running on said server;
medical records software running on said server and including a plurality of patient records; and
call routing software running on said server and capable of identifying the number of an incoming call to said telecommunications manager software, said call routing software capable of obtaining one of said patient records based on the number of the incoming call, and said call routing software capable of forwarding the incoming call with the one of said patient records to a recipient of the incoming call.

14. The call routing system of claim 13 wherein data exchange between said telecommunications manager software and said medical records software is done using HL7 messages.

15. A method for answering an incoming call comprising:
receiving incoming call;
identifying the number of an incoming call; and
identifying a particular patient record based on the number of the incoming call.

16. The method of claim 15 further comprising retrieving and displaying the identified patient record via a web portal.

17. A method for appointment reminders comprising:
querying a plurality of patient records; and
determining patient records having an appointment scheduled.

18. The method of claim 17 further comprising sending a message to said patient, the message including at least one of an audio reminder, a SMS, or an e-mail.

19. The method of claim 17 further comprising sending an electronic mail reminder message to said patient.

20. A method for transcribing medical dictation comprising:
receiving audio message;
converting an audio message to a text message; and
associating text messages with particular data records.

21. The method of claim 20 further comprising updating said data records based on said text messages.

22. A method for routing incoming calls comprising:
receiving an incoming call;
identifying the number of an incoming call;
obtaining patient record using number of incoming call; and
routing said call with said patient record to a recipient of the incoming call.
